(19) United States
(12) Patent Application Publication
(10) Pub. No.: US 2023/0308695 A1
(43) Pub. Date: Sep. 28, 2023

(54) SYSTEM AND METHOD FOR TAGGING OF DATA/CONTENT FOR DISPLAY ON A DISPLAY SCREEN

(71) Applicant: SUREWAVES MEDIATECH PRIVATE LIMITED, BANGALORE (IN)

(72) Inventor: RAJENDRA KUMAR KHARE, BANGALORE (IN)

(21) Appl. No.: 18/188,982

(22) Filed: Mar. 23, 2023

Related U.S. Application Data
(63) Continuation-in-part of application No. 12/741,214, filed on Oct. 13, 2010, now abandoned.

(30) Foreign Application Priority Data
Nov. 4, 2007 (IN) 2515/CHE/2007

(51) Int. Cl. H04N 21/235; H04N 21/231

(52) U.S. Cl. CPC H04N 21/2353; H04N 21/23109

(57) ABSTRACT

A system and method for tagging of data/content for display on a display screen is provided, The system comprising World Wide Web connected to a central server through connecting means, smart IBs capable of sending and receiving data/content, a display media device having interactive means in a short-range wireless network, administrators system to schedule data/content. A plurality of administrators systems configured to schedule the data /content, and wherein the scheduled data/content is fed from a plurality of sources, including an internet, the central server and a broadcast data and wherein the scheduled data/content is pulled from the internet or the central server based on a plurality of parameters, and pushed through the display media placed at a location group, and wherein the plurality of remotely located display media are provided with a plurality of mutually different contents.

### CROSS REFRENCE TO RELATED APPLICATIONS

This invention is a divisional out of the original Patent Application No. filed at Indian patent Office (IPO) with application number 2515/CHE/2007 filed on Nov. 4, 2007. This application is a CIP application to U.S. 12/741214 and claims the priority of the Non-Provisional Pat. Application (NPA) with serial number 12/741,214 filed at USPTO with the title “SYSTEM AND METHOD FOR TAGGING OF DATA/CONTENT FOR DISPLAY ON A DISPLAY SCREEN” and the contents of which is included entirely as reference herein.

### BACKGROUND

### Field of the Invention

The present invention relates to a system and method for tagging of data/content for display on a display media. More particularly, the present invention relates to a system and method for tagging of data/content that will be played on the display media viz. TV, web or mobile display and the like.

### Summary of the Invention

A system and method for tagging of content for display on a display media are provided. Briefly, one exemplary embodiment relates to a system for tagging of data/content for display on a display screen, the system comprising World Wide Web connected to a central server through connecting means, smart IBs capable of sending and receiving data/content, a display media device having interactive means in a short-range wireless network, administrators’ system to schedule data/content.

Another exemplary embodiment relates to a method for tagging of data/content for display on a display screen, the method comprising the steps of inputting data/content, adding tags to such data/content, retrieving available inventory, adding inventory specification, matching tags with said inventory specification, suggesting best matches for the said tags, scheduling data/content on all accepted matches, displaying scheduled data/content.

In another aspect there is provided a method for tagging of data/content for display on a display media of mobile communication device, the method comprising the steps of inputting data/content, adding tags to such data/content, retrieving available’ Smart-IB, retrieving Smart-IB specification, matching tags with specification, suggesting best matches for the said tags, scheduling matched data/content to be added on accepted Smart-IB’s for mobile interaction, recording all interactivity, sending all recorded interactivity to central server for updating and analytics, displaying scheduled data/content.

One object of the present invention is to provide tagging of data/content for display as per the schedule list.

Another object of the present invention to display associated sets of data/content such as advertisement content along with the scheduled data/content after being tagged

Yet another objective of the instant invention is to pull and display information from the internet and/or central server based on plurality of parameters.

Yet another objective of the instant invention is to combine the power of ‘pull’ from the internet with the power to ‘push’ through a TV screen placed at a location group viewing using a remote control through a set of commands transmitted over internet/secure network to the remotely located display media.

Yet another objective of the present invention is to facilitate the use of stored content under remote control which can be used to deliver quality audio and/or video and avoid the effects of trees, bridges, tall buildings etc. for trains and buses thereby removing the poor transmission and reception problems.

### BRIEF DESCRIPTION OF ACCOMPANYING DRAWINGS

Non-limiting and non-exhaustive features of the present invention together with its objects and advantages are described with reference to the accompanying drawings, like reference numerals refer to like elements throughout the various figures unless specified otherwise and wherein:

FIG. 1 illustrates a system for tagging of data/content for display on a display screen according to a preferred embodiment of the present invention.

FIG. 2 illustrates the display embodiments of scheduled data/content after being tagged m different display modes.

FIG. 3 illustrates a block diagram depicting the method for tagging of data/content for display on a display media of mobile communication device according to a preferred embodiment of the present invention.

FIG. 4 illustrates a block diagram depicting the method for tagging of data/content for display on a display screen according to a preferred embodiment of the present invention.

FIG. 5 illustrates the hardware elements of the central server employed m a preferred embodiment of the present invention.

### DETAILED DESCRIPTION OF THE INVENTION

A system and method for tagging of data/content for display on a display media are provided. Also provided, a system and method for tagging of data/content that will be played on the display media viz. TV, web or mobile display and the like.

In the following description for purposes of explanation, specific details are set forth in order to provide a thorough understanding of the present invention. It will be evident, however, to one skilled in the art that the present invention may be practiced without these specific details. In other instances, well known methods, procedures, components and circuits have not been described in detail so as not to obscure the present invention.

The present invention now will be described more fully hereinafter with reference to the accompanying drawings, which form a part hereof, and which show, by way of illustration, specific exemplary preferred embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

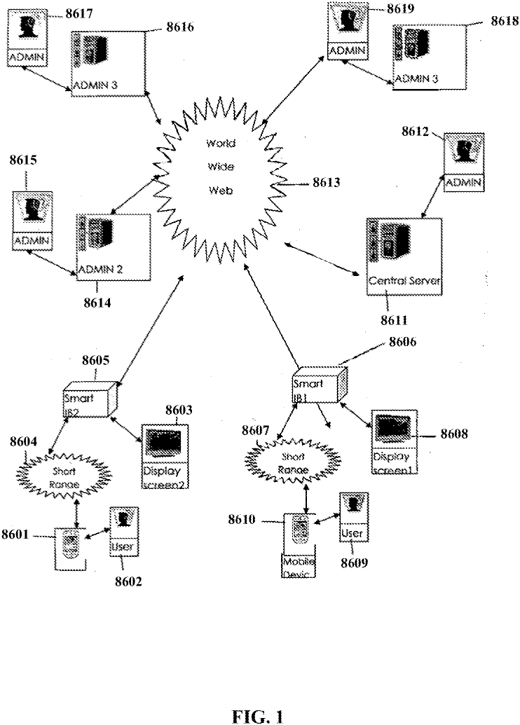

Referring to FIG. 1, it depicts a system for tagging of data/content for display on a display screen, the system comprising World Wide Web 8613 connected to a central server 8611 through connecting means, smart IBs 8605, 8606 capable of sending and receiving data/content, a display media 8603, 8608, device having interactive means in a short range wireless network 8604, 8607, administrators system 8614, 8616, 8618 to schedule data/content. Smart IB is a smart information box or smart intelligent local server like a set top box having hardware units and configured to interact and communicate with mobile devices of a user and display devices through short range -wireless network.

The data/content is tagged for display according to the schedule list. The display media comprises the display screens of TV, web-based interface, the interface of mobile communication device 8601, 8610 and the like. The tagging of data/content carried out as per the schedule list which afterwards fed to the display media along with the associated set of advertisement content which is also played automatically. The carrying out of tagging of data/content including the advertisement content as per the schedule list helps in mapping of the data/content fed to the system. wherein the data/content is tagged based on target group, specification of smart IB and/or inventory specification and location of smart IB.

Whenever, the data/content is uploaded onto the server of the system by various administrators 8612, 8615, 8617, 8619, the said administrators feed the server with information like what the content is all about, who can be the target group etc. All the provided information stored in the central server.

An admin is configured to add tags to content based on the specification and location of smart IB and based on target group, specification of smart IB or inventory specification and location of smart IB,

When a user 8602, 8609 logs into the system he may enter his target group with his requirement. The said requirement may be matched with the tags available with the stored data/content. The user 8602, 8609 may then be suggested to play his requested data/content say advertisement content, before or after the uploaded data/content is being played on the display media 8603, 8608.

The data/content is tagged based on target group, specification of smart IB or inventory specification and location of smart IB.

In the system Admin1 maintains central system. Admin2 may upload some content say advertisement, while uploading the same, admin adds tags to all the content as per the schedule. Thus the system provides for plurality of administrators who may upload data/content. The data/content so uploaded may be displayed on the display media including the screen of a TV, display interface of web, display interface of a mobile communication device and the like. The data/content so uploaded includes the advertisement content.

The central server while scheduling the data/content also keeps these tags into consideration and intimates accordingly to administrator or any other person who is authorised to schedule the data/content.

In a preferred embodiment, administrators may also upload, book and schedule data content such as advertisement content based on the location of the Smart-IB and the specification of the smart IB. The central server has means to match the required profiles and suggest best screens with available inventory at a given time.

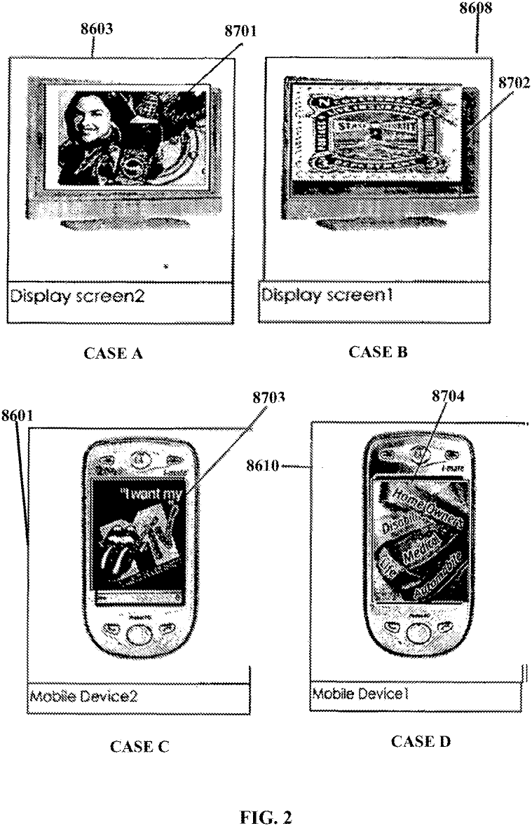

FIG. 2 illustrates the display embodiments 8701, 8702, 8703, 8704 of scheduled data/content after being tagged in different display modes.

The instant invention combines the power of ‘pull’ from the World Wide Web with the power to ‘push’ through a display screen through a set of commands transmitted over World Wide Web (internet)/secure network to the remotely located display devices. The display media is fed with information through different sources like World Wide Web (internet), server, broadcast data and controlled through a centralized location. The display options are configurable based on the scheduled data/content carried out by plurality of administrators in the network. The plurality of remotely located display media or devices are provided with a plurality of mutually different contents.

The scheduled and matched data/content is pulled based on a location of smart. Intelligent local server, and wherein the scheduled and matched data/content is pulled based on a target group, and/or the location of smart IB.

An end-user can view a live feed of a channel on display media (screens) with running advertisements. A customized and localized element of live feed of the data/content can be created for delivery to the end-user from various sources. In a preferred embodiment of the present invention may receive the multimedia-program transmissions having the scheduled/customized data/content from the data server on World Wide Web (Internet) and transmit such multimedia-program transmissions to the display media (screens) from the various sources. For example, the end-user can view a list of available TV programs on a website associated with a cable TV station whereby scheduled/customized data/content (live feed of customized data/content) can be created for delivery to the display media (screens) that incorporates portions of audio/video elements from one or more TV channels or other sources as per the effective relevancy of the advertisements on display.

In accordance with a invention, each of preferred embodiment of the present invention, each of the plurality of multimedia-program transmissions may comprise a plurality of television channels, a plurality of internet transmissions, etc. The plurality of multi-media program transmissions may be conveyed to content servers residing at a plurality of cable TV service provider locations.

The audio video (AN) transmissions may be accumulated in a content server, for example- A data/content server is an information storage unit adapted to collect, accumulate, package, disseminate, and broadcast multimedia- (AN) program data/information to clients at various locations remote from the central office. A common central content server may be located in a central office of a service provider.

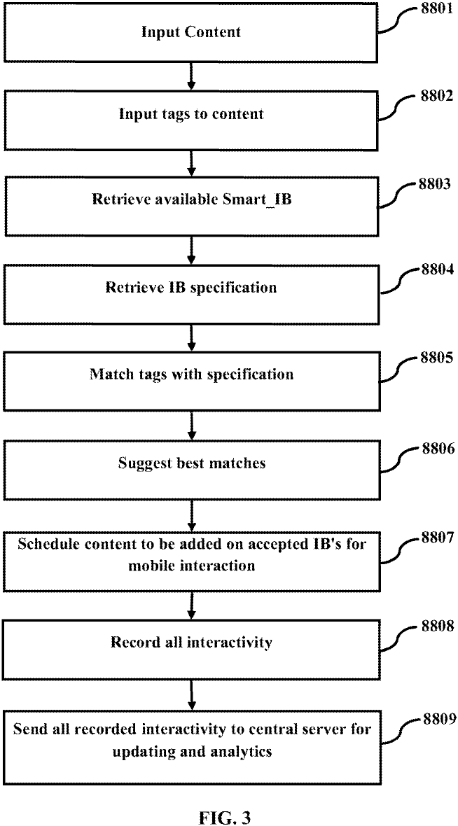

FIG. 3 illustrates a method for tagging of data/content for display on a display media of mobile communication device, the method comprising the steps of inputting data/content (8801), adding tags to such data/content (8802), retrieving available Smart-IB (8803), retrieving Smart-IB specification (8804), matching tags with specification (8805), suggesting best matches for the said tags (8806), scheduling matched data/content to be added on accepted Smart-IB’s for mobile interaction (8807), recording all interactively (8808), sending all recorded interactively to central server for updating and analytics, displaying scheduled data/content (8809).

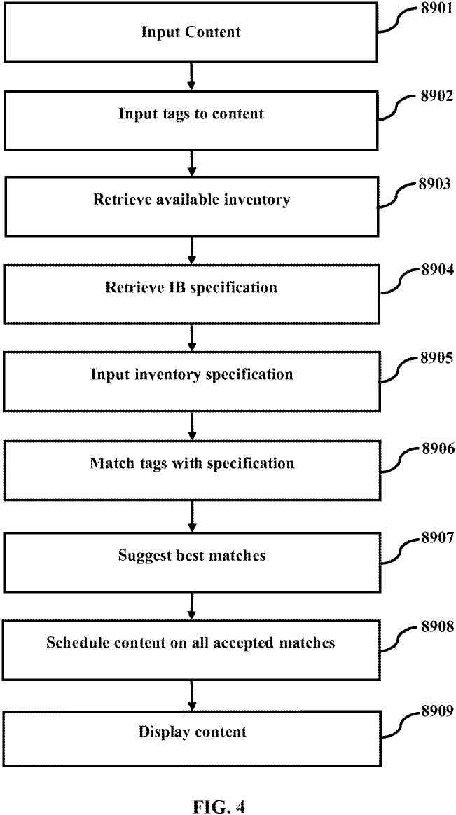

FIG. 4 illustrates a method for tagging of data/content for display on a display screen, the method comprising the method comprising the steps of inputting data/content 8901, adding 8902 tags to such data/content, retrieving 8903 available inventory, adding inventory 8904 specification, matching tags 8905 with said inventory specification, suggesting 8906 best matches for the said tags, scheduling data/content 8907 on all accepted matches, displaying 8908 scheduled data/content.

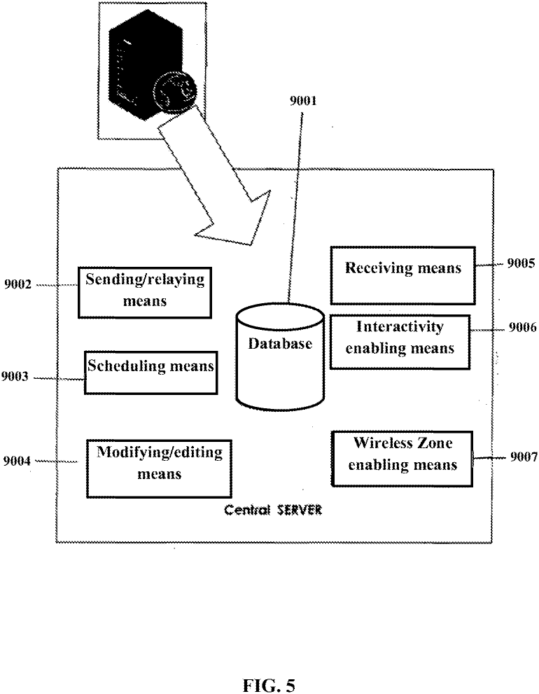

FIG. 5 illustrates the hardware elements of the central server wherein the central server comprises sending and/or relaying means 9002, scheduling means 9003, modifying and/or editing means 9004, receiving means 9005, interactively enabling means 9006 to enable interactively, wireless zone enabling means 9007, database 9001 containing display data/content.

Interactivity means enable interactivity to interpret and allow data/content to be downloaded. The interactivity means also facilitate to forward the query to the central server for further processing. Wireless enabling means make the whole area as a short range wireless network facilitating the interactivity between the component of the present invention.

The system integrates an intelligent hardware with an electronic display. The hardware contains the intelligence to receive commands/content through broadband, wireless, Bluetooth or a similar communication channel. The hardware further comprised the intelligence to analyse the location-based context. Based on the analysis of the context the system and method thereof can pull content from internet and/or central location and push the content on an electronic display viewed by a group of viewers at a certain location/or a group of locations.

The blocks of the flowchart illustration support combinations of means for performing the specified actions, combinations of steps for performing the specified actions and program instruction means for performing the specified actions.

Although, the invention has been described with reference to specific examples, it would be appreciated by those skilled in the art that the invention may be embodied in many forms without departing from the broader spirit and scope of the invention as set forth in the invention. Preferred embodiments of this invention have been described herein, including the best mode known to the inventor for carrying out the invention. Variations of those preferred embodiments may become apparent to those of ordinary skill in the art upon reading the foregoing description.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Accordingly, the specification and drawings are to be regarded in an illustrative rather than a restrictive sense without departing from the spirit and scope of the invention, the invention resides in the claims hereinafter appended.

What is claimed is:

1. A method for tagging of data/content for display on a display media of a mobile communication device, the method comprising the steps of:
inputting a data/content;
adding tags to the data/content, and wherein the tags are added based on a schedule list, and wherein the data/content is tagged based on target group, specification of smart IB or inventory specification and location of smart IB;
retrieving an available Smart-Intelligent local server;
retrieving a Smart-Intelligent local server (smart IB) specification;
matching the tags with the specification of the smart IB or inventory specification;
suggesting matches for the tags based on a requirement of an input target group;
scheduling a matched data/content to be added on accepted Smart-Intelligent local server for a mobile interaction, and wherein the matched data/content is scheduled by a plurality of administrators systems;
recording all interactivity, wherein an interactivity is performed to interpret and allow the scheduled and matched data/content to be downloaded;
sending all recorded interactivity to a central server for updating and analytics;
displaying the scheduled and matched data/content, and wherein the scheduled and matched data/content is fed from a plurality of sources, and wherein the plurality of sources includes an internet, the central server and a broadcast data and wherein the scheduled and matched data/content is pulled from the internet or the central server and pushed through a display media placed at a location group through a set of commands transmitted over the internet or a secured network to the display media, and wherein the display media comprises a display screen of TV, web based interface, and an interface of mobile communication device, wherein the scheduled and matched data/content is pulled from the internet or the central server based on a plurality of parameters and wherein the scheduled and matched data/content is pulled based on a location of smart Intelligent local server, and wherein the scheduled and matched data/content is pulled based on a target group and wherein the target group is entered by a user, and wherein the display media is a remotely located display media and wherein the display media has an interactive means in a short range wireless network, and wherein the set of commands are received through a broadband or a wireless or an Intelligent communication channel, and wherein a plurality of multimedia program transmissions having the scheduled and matched data/content is received from the plurality of multimedia program transmissions to the display media, and wherein the plurality of multimedia program transmissions includes a plurality of television channels and a plurality of internet transmissions, and wherein a requested data/content is displayed before or after a playing of the scheduled and matched data/content, and wherein the requested data/content is an advertisement data, and wherein an audio content and a video content are delivered by a central server to buses and trains by using stored data/content or an audio is delivered by using stored data/content thereby removing an effect or interference of trees, bridges and tall buildings, and wherein the scheduled and matched data/content is a live feed of customized data/content and wherein the live feed of customized data/content is created to include portions of the audio content and/or video contents from one or more TV channels or other sources, that are relevant to the advertisement data on display, and wherein a live feed of a channel is displayed on a display media with a running of live advertisements for an user, and wherein a customized and localized element of live feed of the data/content is created for the user from various sources, and wherein the advertisement data is selected based on a location of the Smart-Intelligent local server and wherein a plurality of display options are configurable based on the scheduled and matched data/content, and wherein the display options are configurable based on the scheduled and matched data/content carried out by plurality of administrators systems, and wherein screens are suggested based on available inventory and required profile at a given time and wherein the set of commands are transmitted over internet or secured network to pull the data/content from the World Wide Web and to push the pulled data/content to a plurality of remotely located display media, and wherein the data/content is pulled from the internet and/or central location based on analysis of a location based context, and wherein the pulled data/content is pushed on an electronic display viewed by a group of viewers at a given location/or a group of locations, and wherein the plurality of remotely located display media are provided with a plurality of mutually different data/content.

2. The method as claimed in claim 1, wherein the central server schedules the data/content as per the tags.

3. A method for tagging of data/content for display on a display screen, the method comprising the steps of:
inputting a data/content;
adding tags to the data/content, and wherein the tags are added based on a schedule list, and wherein the schedule list is fed to a display media, and wherein the data/content is tagged based on target group, specification of smart IB and location of smart IB;
retrieving an available inventory; adding inventory specification;
matching the tags with said inventory specification;
suggesting best matches for the tags based on a requirement of an input target group;
scheduling a data/content on all accepted matches, wherein a central server schedules the data/content as per the tags;
recording all interactivity, wherein an interactivity is performed to interpret and allow the data/content to be downloaded;
sending all recorded interactivity to a central server for updating and analytics;
displaying the scheduled data/content, and wherein the scheduled data/content is fed from a plurality of sources, and wherein the plurality of sources includes an internet, the central server and a broadcast data and wherein the scheduled data/content is pulled from the internet or the central server based on a plurality of parameters and pushed through the display media placed at a location group through a set of commands transmitted over the internet or a secured network to the display media, and wherein the scheduled data/content is pulled based on a target group and wherein the target group is entered by a user, and wherein the display media is a plurality of remotely located display media and wherein the display media comprises a display screen of TV, web based interface, and an interface of mobile communication device, and wherein the display media has an Interactive means in a short range wireless network and wherein the set of commands are received through a broadband or a wireless or a communication channel, and wherein a plurality of multimedia program transmissions having the scheduled data/content is received from the plurality of sources and transmitting the plurality of multimedia program transmissions to the display media, and wherein the plurality of multimedia program transmissions includes a plurality of television channels and a plurality of internet transmissions, and wherein a requested data/content is displayed before or after a playing of the scheduled data/content, and wherein the requested data/content is an advertisement data, and wherein an audio data/content and a video data/content are delivered to buses and trains by using stored data/content thereby, removing an effect or interference of trees, bridges and tall buildings, and wherein the scheduled data/content is a live feed of customized data/content and wherein the live feed of customized data/content is created to include portions of the audio data/content and/or video data/content from one or more TV channels or other sources, relevant to the advertisement data on display, and wherein the live feed of a channel is displayed on the display media with a running of live advertisement data for the user, and wherein a customized and localized element of live feed of the data/content is created for the user from various sources, and wherein the advertisement data is selected based on a location of a Smart-Intelligent local server and wherein a plurality of display options is configured based on the scheduled data/content, and wherein the display options are configured based on the scheduled data/content carried out by a plurality of administrators in the system, and wherein screens are suggested based on available inventory and required profile at a given time, and wherein the set of commands are transmitted over internet or secured network to pull the data /content from the World Wide Web and to push the pulled data/content to a plurality of remotely located display media, and wherein the data/content is pulled from the internet and/or central location based on analysis of a location based context, and wherein the pulled data/content is pushed on an electronic display viewed by a group of viewers at a given location/or a group of locations, and wherein the plurality of remotely located media are provided with a plurality of mutually different contents.

4. The method as claimed in claim 3, wherein the data/content including the advertisement data/content is tagged as per the schedule list to map the data/content fed to the display system.

5. A system for tagging of data/content for display on a display screen, the system comprising:
a central server connected to a World Wide Web through a network;
a display media device having an interactive means connected to smartIB through a short-range wireless network;
a plurality of administrators systems configured to schedule the data /content, and wherein the scheduled data/content is fed from a plurality of sources, and wherein the plurality of sources includes an internet, the central server and a broadcast data and wherein the scheduled data/content is pulled from the internet or the central server based on a plurality of parameters, and pushed through the display media placed at a location group through a set of commands transmitted over the internet or a secured network to the display media, and wherein the scheduled data/content is pulled based on a location of a smart Intelligent local server and wherein the scheduled data/content is pulled based on a target group and wherein the target group is entered by a user, and wherein the display media is a plurality of remotely located display media, and wherein the set of commands are received through a broadband or a wireless or a communication channel, and wherein the plurality of administrators system tags the data/content while uploading said data/content into the central server and wherein the plurality of administrators system tags the data/content as per a schedule list which is fed to the display media along with an associated set of advertisement data/content to map the data/content to the system, and wherein the administrators system schedules the data/content based on the location of the smart-Intelligent local server, and wherein the data/content is tagged based on a target group, specification of smart IB or inventory specification and location of smart IB, and wherein the central server receives a plurality of multimedia program transmissions having the scheduled data/content from the plurality of sources and transmitting the plurality of multimedia program transmissions to the display media, and wherein the plurality of multimedia program transmissions includes a plurality of television channels and a plurality of internet transmissions, and wherein the central server displays a requested data/content before or after a playing of the scheduled data/content, and wherein the requested data/content is an advertisement data/content, and wherein the central server is configured to deliver an audio and a video to buses and trains by using stored data/content thereby removing an effect or interference of trees, bridges and tall buildings, and wherein the scheduled data/content is a live feed of customized data/content, and wherein the live feed of customized data/content is created to include portions of an audio and/or video data/content from one or more TV channels or other sources, relevant to the advertisement data/content on display, and wherein a live feed of a channel is displayed on the plurality of remotely located display media with a running of live advertisements for the user, and wherein a customized and localized elements of the live feed of the data/content is created for the user from various sources, and wherein the advertisement data/content is selected based on a location of the Smart-Intelligent local server, and wherein a plurality of displays are configured based on the scheduled data/content, and wherein a plurality of display options are configurable based on the scheduled data/content carried out by the plurality of administrators in the system, and wherein screens are suggested based on available inventory and required profile at a given time and wherein the set of commands are transmitted over internet or secured network to pull the data/content from the World Wide Web and to push the pulled data/content to the remotely located display media, and wherein the data/content is pulled from the integrated and/or central location based on analysis of a location based context, and wherein the pulled data/content is pushed on an electronic display viewed by a group of viewers at a given location/or a group of locations, wherein the display media comprises a display screen of TV, web based interface, and an interface of mobile communication device, and wherein the plurality of remotely located display media are provided with a plurality of mutually different contents.

6. The system as claimed in claim 5, wherein the central server further comprises:
a sending and/or relaying unit configured for transmitting the plurality of multitude program transmissions to the display media and for sending all recorded interactivity to a central server for updating and analytics;
a scheduling module unit configured for scheduling a matched data/content to be added on accepted Smart-Intelligent local server for a mobile interaction;
a receiving module unit configured for receiving a plurality of multimedia program transmissions having the scheduled data/content;
an interactivity enabling module unit configured to enable an interactivity to interpret and allow data/content to be downloaded and wherein interactivity enabling unit is further configured to forward a query to central server for processing;
a wireless zone enabling module unit configured to enable a specified area as short-range wireless zone;
a database configured to store display data/content.

7. The system as claimed in claim 5, wherein the administrators system tags the data/content including the advertisement data/content as per the schedule list to map the data/content fed to the display system.
